(19) United States
(12) Patent Application Publication
(10) Pub. No.: US 2026/0155540 A1
(43) Pub. Date: Jun. 4, 2026

(54) ELECTRODE ASSEMBLY AND RECHARGEABLE LITHIUM BATTERY INCLUDING THE SAME

(71) Applicant: SAMSUNG SDI CO., LTD., Yongin-si (KR)

(72) Inventor: Jaewook KIM, Yongin-si (KR)

(73) Assignee: SAMSUNG SDI CO., LTD., Yongin-si (KR)

(21) Appl. No.: 19/407,884

(22) Filed: Dec. 3, 2025

(30) Foreign Application Priority Data
Dec. 4, 2024 (KR) 10-2024-0178782

(51) Int. Cl. H01M 50/534; H01M 4/02; H01M 4/38; H01M 4/505; H01M 4/525; H01M 4/58; H01M 10/0525; H01M 50/107; H01M 50/533; H01M 50/538

(52) U.S. Cl. CPC H01M 50/534; H01M 4/386; H01M 4/505; H01M 4/525; H01M 4/5825; H01M 10/0525; H01M 50/107; H01M 50/533; H01M 50/538; H01M 2004/027; H01M 2004/028

(57) ABSTRACT

Disclosed are an electrode assembly and a rechargeable lithium battery. The electrode assembly includes at least one unit cell including a positive electrode and a negative electrode, and at least one electrode tab electrically connected to any one of the positive electrode and the negative electrode. The electrode tab includes a first metal layer, a second metal layer, and a polymer layer interposed between the first metal layer and the second metal layer. The polymer layer includes a polymer having a thermal conductivity in a range of about 10 W/m K or less.

### CROSS-REFERENCE TO RELATED APPLICATIONS

This U.S. non-provisional patent application claims priority under 35 U.S.C. § 119 of Korean Patent Application No. 10-2024-0178782, filed on Dec. 4, 2024, the entire contents of which are hereby incorporated by reference.

### BACKGROUND

The present disclosure relates to an electrode assembly and a rechargeable lithium battery including the electrode assembly.

The increase of battery-powered electronics, such as, e.g., mobile phones, laptop computers, electric vehicles, and the like, has increased demand for rechargeable batteries having high energy density and high capacity. Accordingly, improving the performance of rechargeable lithium batteries may be advantageous.

Rechargeable lithium batteries include a positive electrode and a negative electrode, each including an active material that allows intercalation and deintercalation of lithium ions, and an electrolyte solution, and produce electrical energy from redox reactions that take place as lithium ions are intercalated into or deintercalated from the positive electrode and the negative electrode.

### SUMMARY

The present disclosure describes an electrode assembly capable of reducing or preventing deformation of electrodes in batteries due to volume changes while having desired or improved life characteristics and safety.

An example embodiment of the present disclosure includes an electrode assembly including at least one unit cell including a positive electrode and a negative electrode, and at least one electrode tab electrically connected to any one of the positive electrode and the negative electrode. The electrode tab includes a first metal layer, a second metal layer, and a polymer layer interposed between the first metal layer and the second metal layer, and the polymer layer includes a polymer having a thermal conductivity in a range of about 10 W/m K or less.

In an example embodiment of the present disclosure, a rechargeable lithium battery includes a wound electrode assembly, and a cylindrical outer casing that houses the wound electrode assembly. The wound electrode assembly includes a positive electrode, a negative electrode, and at least one electrode tab electrically connected to the negative electrode. The negative electrode active material layer includes a Si-based negative electrode active material, and the electrode tab includes a first metal layer, a second metal layer, and a polymer layer interposed between the first metal layer and the second metal layer.

### BRIEF DESCRIPTION OF THE FIGURES

The accompanying drawings are included to provide a further understanding of the present disclosure, and are incorporated in and constitute a part of this specification. The drawings illustrate embodiments of the present disclosure and, together with the description, explain principles of the present disclosure. In the drawings:

FIG. 1 schematically shows a typical rechargeable lithium battery;

FIG. 2 shows a structure of a cylindrical rechargeable lithium battery;

FIG. 3 is a cross-sectional view of an electrode tab according to an example embodiment of the present disclosure;

FIG. 4 is a cross-sectional view of an electrode assembly according to an example embodiment of the present disclosure;

FIG. 5 is a schematic cross-sectional view enlarging region “M” of FIG. 4;

FIG. 6 is a cross-sectional view of a rechargeable lithium battery according to another example embodiment of the present disclosure; and

FIG. 7 is a schematic cross-sectional view enlarging region N of FIG. 6.

### DETAILED DESCRIPTION

In order to sufficiently understand the configuration and effects of the present disclosure, example embodiments of the present disclosure are described with reference to the accompanying drawings. It should be noted, however, that the present disclosure is not limited to the following embodiments, and may be implemented in various forms and variously modified. The example embodiments herein are provided so that the present disclosure is thorough and complete and fully conveys the scope of the present disclosure to those skilled in the art.

Herein, it is understood that when a component is referred to as being “on” another component, the component may be “directly on” the other component, or an intervening third component may be present therebetween. In addition, in the drawings, thicknesses of components may be exaggerated for effectively describing technical contents. Like reference numerals refer to like elements throughout.

The example embodiments described herein are explained with reference to the cross-sectional views and/or plan views as ideal example views of the present disclosure. In the drawing, the thicknesses of films and regions may be exaggerated for effective description of the technical contents. Thus, regions presented as an example in the drawings have general properties, and shapes of the exemplified areas are used to illustrate a specific shape of a device region. Therefore, this should not be construed as limited to the scope of the present disclosure.

Herein, “one surface” and “another surface” are terms used to distinguish between different surfaces of an object, where “one surface” refers to a specific surface of the object, and “another surface” refers to a surface located on the opposite side or in a different direction from the one surface.

Although the terms such as “first,” “second,” and “third” are used to describe various components in various example embodiments herein, the components should not be limited to these terms. These terms are used only to distinguish one component from another component. Example embodiments described and exemplified herein include complementary embodiments thereof.

All numbers and expressions related to quantities of components, reaction conditions, and the like used herein are to be understood as being modified in all instances by the term “about,” unless otherwise indicated.

Terms used herein are not for limiting the present disclosure but for describing the example embodiments. As used herein, the singular forms include the plural forms as well, unless the context clearly indicates otherwise. The meaning of ‘comprises’ and/or ‘comprising’ used herein does not exclude the presence or addition of one or more other components besides a mentioned component.

As used herein, the term “combination thereof” may refer to a mixture, a stack, a composite, a copolymer, an alloy, a blend, or a reaction product.

Unless otherwise defined herein, a particle diameter may be an average particle diameter. In addition, a particle diameter is defined as an average particle diameter (D50) indicating the diameter of particles at a cumulative volume of about 50 vol % in particle size distribution. The average particle diameter (D50) may be measured by a method known to those skilled in the art, for example, by a particle size analyzer, a transmission electron micrograph, or a scanning electron micrograph. Alternatively, an average particle diameter (D50) value may be obtained by measuring a subject using a dynamic light-scattering-based measuring device, performing data analysis, counting the number of particles for each particle size range, and then calculating the value therefrom. Alternatively, the average particle diameter (D50) may be measured using a laser diffraction method. In the measuring using the laser diffraction method, for example, target particles are dispersed in a dispersion medium, introduced into a commercially available laser diffraction particle diameter measuring device (e.g., MT 3000 available from Microtrac, Ltd.), irradiated with ultrasonic waves of about 28 kHz at a power of 60 W, and then an average particle diameter (D50) based on 50% of the particle diameter distribution in the measuring device may be calculated.

Herein, the term “metal” includes both metals and metalloids such as silicon and germanium, in an elemental or ionic state, and the term “alloy” refers to a mixture of two or more metals.

Herein, the term “positive electrode active material” refers to a positive electrode material that may undergo lithiation and delithiation, and the term “negative electrode active material” refers to a negative electrode material that may undergo lithiation and delithiation.

Herein, the terms “lithiation” and “to lithiate” refer to a process of adding lithium to an electrode active material, and the terms “delithiation” and “to delithiate” refer to a process of removing lithium from an electrode active material.

Herein, the terms “charging” and “to charge” refer to a process of providing electrochemical energy to a battery, and the terms “discharging” and “to discharge” refer to a process of removing electrochemical energy from a battery.

Herein, the terms “positive electrode” and “cathode” refer to an electrode at which electrochemical reduction and lithiation take place during a discharging process, and the terms “negative electrode” and “anode” refer to an electrode at which electrochemical oxidation and delithiation take place during a discharging process.

Herein, the term “ionic conductivity” refers to the ability of ions to move within a material, which indicates the degree to which ions, such as lithium ions, may smoothly move between electrodes, and the term “electronic conductivity” refers to the ability of electrons to move within a material, which indicates the degree to which electrons may smoothly move between electrodes.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

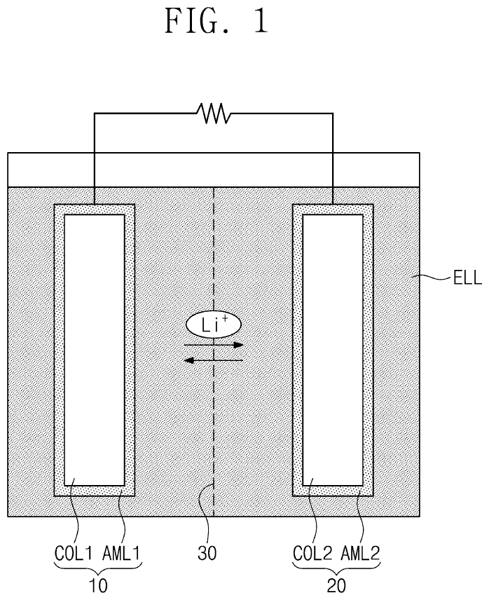

FIG. 1 schematically illustrates a typical rechargeable lithium battery. Referring to FIG. 1, the rechargeable lithium battery may include a positive electrode 10, a negative electrode 20, a separator 30, and an electrolyte solution ELL.

The positive electrode 10 and the negative electrode 20 may be spaced apart from each other with the separator 30 therebetween. The separator 30 may be disposed between the positive electrode 10 and the negative electrode 20. The positive electrode 10, the negative electrode 20, and the separator 30 may be in contact with the electrolyte solution ELL. The positive electrode 10, the negative electrode 20, and the separator 30 may be impregnated in the electrolyte solution ELL. In this case, the positive electrode 10 may include a positive electrode current collector COL1 and a positive electrode active material layer AML1, and the negative electrode 20 may include a negative electrode current collector COL2 and a negative electrode active material layer AML2.

The electrolyte solution ELL may be or include a medium for transferring lithium ions between the positive electrode 10 and the negative electrode 20. In the electrolyte solution ELL, the lithium ions may move through the separator 30 toward the positive electrode 10 or the negative electrode 20.

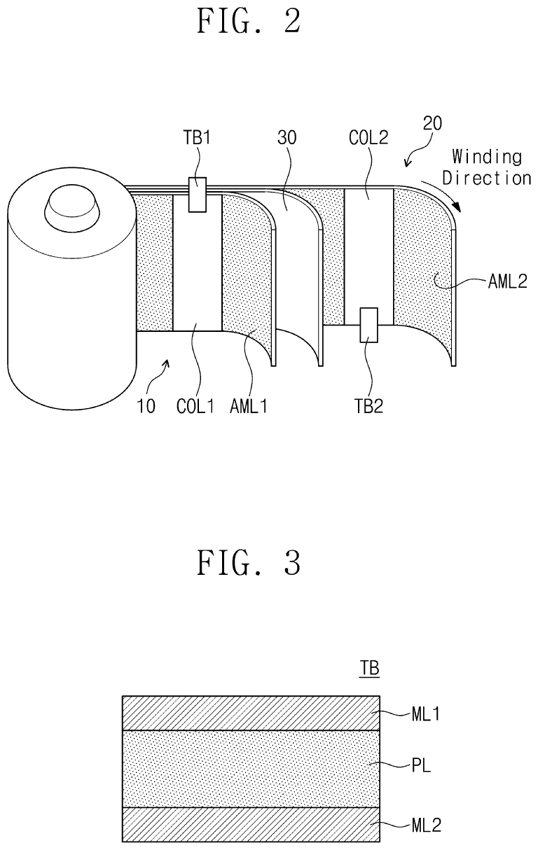

FIG. 2 illustrates a structure of a cylindrical rechargeable lithium battery. Referring to FIG. 2, the cylindrical rechargeable lithium battery may include an electrode assembly having a positive electrode 10, a negative electrode 20, and a separator 30 interposed between the positive electrode 10 and the negative electrode 20. For example, the cylindrical rechargeable lithium battery may include an electrode assembly in which the negative electrode 20, the separator 30, and the positive electrode 10 are wound, and a positive electrode tab TB1 electrically connected to the positive electrode 10 may be disposed on an upper portion of a positive electrode current collector COL1, and a negative electrode tab TB2 electrically connected to the negative electrode 20 may be disposed on a lower portion of a negative electrode current collector COL2.

A cylindrical rechargeable lithium battery that may be used in, e.g., laptops, electric vehicles, and energy storage systems (ESS) is suitable for mass production and resistant to external impacts due to a cylindrical structure thereof, but has low space efficiency inside the battery and hardly enables internal heat dissipation due to the cylindrical structure thereof. In addition, the electrode assembly including an electrode may be torn or cracked when wound into a circular shape, which may cause electrolyte leakage. Accordingly, an electrode assembly capable of reducing or preventing defects such as cracks or electrolyte leakage even when wound into a circular shape, while also exhibiting desired or improved life characteristics and safety may be advantageous.

The electrode assembly according to an example embodiment of the present disclosure includes an electrode tab including a first metal layer, a second metal layer, and a polymer layer interposed between the first metal layer and the second metal layer, and may thus reduce or prevent deformation of an electrode in a battery due to volume changes caused by charging/discharging or the like, thereby improving life characteristics and safety. For example, the electrode tab includes the polymer layer, and may thus disperse external pressure applied due to volume changes or the like, thereby effectively reducing or preventing defects such as cracks or electrolyte leakage. For example, the polymer layer includes a polymer having a thermal conductivity of about 10 W/m K or less, and may thus reduce heat transfer occurring inside the battery, thereby exhibiting desired or improved safety. In addition, the polymer layer includes a polymer having an electrical conductivity in a range of about 1.0×10⁻² S/cm to about 1.0×10⁵ S/cm, and thus may not need a separate tab such as a lead tab, resulting in no need of a complex tab design.

### Electrode Assembly

The example embodiment of the present disclosure includes an electrode including at least one unit cell including a positive electrode and a negative electrode, and at least one electrode tab electrically connected to any one of the positive electrode and the negative electrode, wherein the electrode tab includes a first metal layer, a second metal layer, and a polymer layer interposed between the first metal layer and the second metal layer, and the polymer layer includes a polymer having a thermal conductivity in a range of about 10 W/m K or less.

### Electrode Tab

The electrode tab according to an example embodiment of the present disclosure includes a first metal layer, a second metal layer, and a polymer layer interposed between the first metal layer and the second metal layer.

FIG. 3 is a cross-sectional view of an electrode tab according to an example embodiment of the present disclosure. Referring to FIG. 3, the electrode tab TB may include a first metal layer ML1, a second metal layer ML2, and a polymer layer PL interposed between the first metal layer ML1 and the second metal layer ML2.

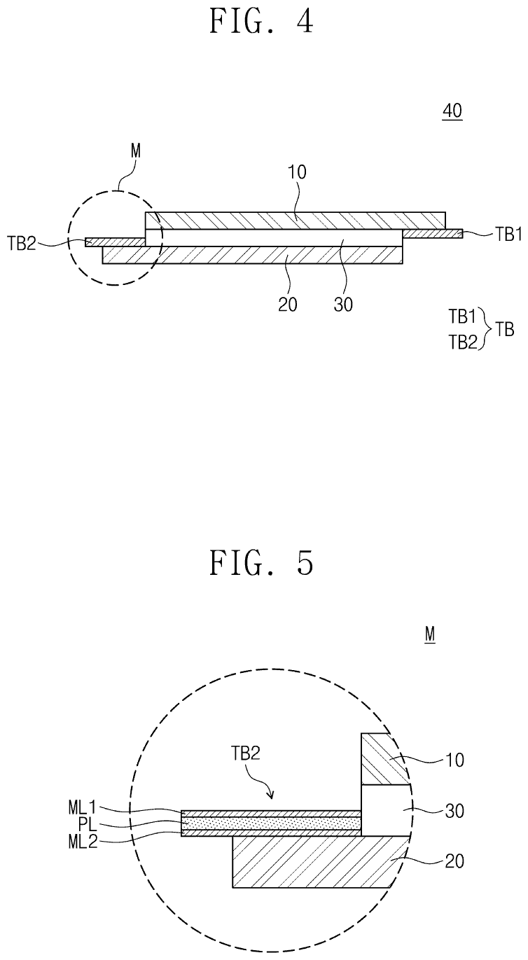

FIG. 4 is a cross-sectional view of an electrode assembly according to an example embodiment of the present disclosure. Referring to FIG. 4, the electrode assembly 40 may include a positive electrode 10, a negative electrode 20, a separator 30, and an electrode tab TB.

The electrode tab TB may include a positive electrode tab TB1 protruding from the positive electrode, and a negative electrode tab TB2 protruding from the negative electrode. In addition, a direction in which the positive electrode tab TB1 protrudes and a direction in which the negative electrode tab TB2 protrudes may be opposite to each other (see FIG. 4).

For example, the electrode assembly 40 may have a structure in which the negative electrode 20, the separator 30, and the positive electrode 10 are stacked, e.g., sequentially stacked, the electrode tab TB may include the positive electrode tab TB1 and the negative electrode tab TB2, the positive electrode tab TB1 may be electrically connected to the positive electrode 10, and the negative electrode tab TB2 may be electrically connected to the negative electrode 20. In this case, electrical connection methods are not particularly limited, and methods such as welding, soldering, and brazing may be used (see FIG. 4).

FIG. 5 is a schematic cross-sectional view enlarging region “M” of FIG. 4. Referring to FIG. 5, the negative electrode tab TB2 may include a first metal layer ML1, a second metal layer ML2, and a polymer layer PL. For example, the negative electrode tab TB2 may have a structure in which the second metal layer ML2, the polymer layer PL, and the first metal layer ML1 are stacked, e.g., sequentially stacked, and the second metal layer ML2 may be electrically connected while in contact with the negative electrode 20, for example, while in contact with the negative electrode current collector COL2 illustrated in FIG. 4.

The polymer layer may include a polymer having a thermal conductivity in a range of about 10 W/m K or less. For example, the polymer may have a thermal conductivity of about 8 W/mK or less, about 6 W/mK or less, about 3 W/mK or less, about 2 W/mK or less, about 0.1 W/mK to about 10 W/mK, about 0.1 W/mK to about 8 W/mK, about 0.1 W/mK to about 6 W/mK, about 0.1 W/mK to about 3 W/mK, or about 0.1 W/mK to about 2 W/mK. The polymer layer includes a polymer having a thermal conductivity satisfying the above range, and thus heat generation occurring at the electrode tab may be reduced or prevented, and heat transfer occurring inside the battery may be reduced, thereby improving safety.

In addition, the polymer layer may include a polymer having a young's modulus in a range of about 5 GPa or less. For example, the polymer may have a young's modulus of about 3 GPa or less or about 1 GPa or less, and may have a young's modulus of about 0.01 GPa to about 5 GPa, about 0.05 GPa to about 5 GPa, about 0.1 GPa to about 5 GPa, or about 0.2 GPa to about 3 GPa. The polymer layer includes a polymer having a young's modulus satisfying the above range, external pressure applied due to volume changes or the like may be dispersed, and thus defects such as cracks or electrolyte leakage may be effectively reduced or prevented, thereby improving life characteristics and safety.

In addition, the polymer layer may include a polymer having an electrical conductivity in a range of about 1.0×10⁻² S/cm to about 1.0×10⁵ S/cm. For example, the polymer may have an electrical conductivity in a range of about 1.0×10⁻² S/cm to about 5.0×10⁴ S/cm or about 1.0×10⁻² S/cm to about 1.0×10⁴ S/cm. The polymer layer includes a polymer having an electrical conductivity satisfying the above range, a certain amount of current may flow to the electrode tab itself, and thus, a separate tab such as a lead tab may not be required. Accordingly, a complex tab design may not be required, and the efficiency of the internal space of the battery may be improved.

The polymer layer may include at least one of polypyrrole, polyaniline, polyphenylene, polyazulene, polythiophene, poly p-phenylene, poly p-phenylene vinylene, polyacetylene, polynaphthalene, polyphenylene sulfide, poly(3,4-ethylenedioxythiophene):polystyrene sulfonate, or a combination thereof.

The polymer layer may have a thickness in a range of about 0.5 μm to about 100 μm, about 0.5 μm to about 60 μm, about 1 μm to about 35 μm, or about 2 μm to about 30 μm.

The first metal layer and the second metal layer may be the same or different. For example, the first metal layer and the second metal layer may have the same or different components, and may have the same or different thicknesses.

The first metal layer and the second metal layer may each include at least one of Ni, Cu, Al, Ti, stainless steel (SUS), or an alloy thereof. For example, the first and second metal layers of the positive electrode tab may include the same metal as the positive electrode current collector, and the first and second metal layers of the negative electrode tab may include the same metal as the negative electrode current collector. As an example, the second metal layer of the positive electrode current collector and the positive electrode tab may each include Al, and the second metal layer of the negative electrode current collector and the negative electrode tab may each include at least one of Cu, Ni, or an alloy of Cu and Ni, but the example embodiment of the present disclosure is not limited thereto.

In addition, the first and second metal layers of the positive electrode tab may have a lower electrical conductivity than the first and second metal layers of the negative electrode tab. In addition, the first and second metal layers of the positive electrode tab may have a lower hardness than the first and second metal layers of the negative electrode tab.

The first metal layer and the second metal layer may each have a thickness in a range of about 0.1 μm to about 50 μm, about 0.1 μm to about 40 μm, or about 0.2 μm to about 30 μm.

The polymer layer may be thicker than each of the first metal layer and the second metal layer. For example, a thickness ratio of the first metal layer, the polymer layer, and the second metal layer may be about 1:2 to 30:0.5 to 1.5, about 1:2 to 15:0.5 to 1.5, or about 1:2 to 10:0.5 to 1. When the thickness ratio of the first metal layer, the polymer layer, and the second metal layer satisfies the above range, life characteristics and safety may be further improved.

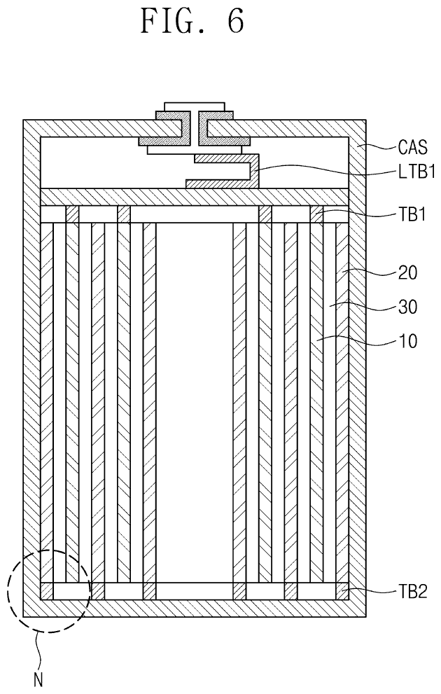

An electrode assembly according to another example embodiment of the present disclosure may further include a lead tab electrically connected to the electrode tab. For example, the lead tab may include a positive electrode lead tab electrically connected to the positive electrode tab, and a negative electrode lead tab electrically connected to the negative electrode tab. For example, the electrode assembly may include a positive electrode lead tab or a negative electrode lead tab, and may include both a positive electrode lead tab and a negative electrode lead tab. As an example, as shown in FIG. 6, the electrode assembly may include a positive electrode lead tab LTB1. The electrode assembly includes a polymer layer including a polymer having an electrical conductivity in a range of about 1.0×10⁻² S/cm to about 1.0×10⁵ S/cm, and thus, a separate lead tab may not be required.

### Positive Electrode

The electrode assembly according to an example embodiment of the present disclosure includes a positive electrode 10. For example, the positive electrode 10 may include a positive electrode current collector COL1 and a positive electrode active material layer AML1 disposed on at least one surface of the positive electrode current collector COL1. The positive electrode active material layer AML1 may include a positive electrode active material, and may further include a binder and/or a conductive material.

The positive electrode active material layer AML1 may contain about 90 wt % to about 99.5 wt % of the positive electrode active material with respect to 100 wt % of the positive electrode active material layer AML1. For example, the positive electrode active material may amount to a range of about 92 wt % to about 99.5 wt %, or about 95 wt % to about 99 wt %, with respect to 100 wt % of the positive electrode active material layer AML1.

A compound capable of reversibly intercalating and deintercalating lithium (lithiated intercalation compound) may be used as a positive electrode active material in the positive electrode active material layer AML1. For example, at least one of a composite oxide of lithium and a metal such as or including at least one of cobalt, manganese, nickel, and a combination thereof may be used.

The composite oxide may be or include a lithium transition metal composite oxide, and examples thereof may include at least one of lithium nickel-based oxide, lithium cobalt-based oxide, lithium manganese-based oxide, lithium iron phosphate-based compound, cobalt-free nickel-manganese-based oxide, or a combination thereof.

The positive electrode active material may include a lithium composite oxide represented by Formula 1 below.

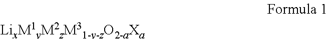

In Formula 1 above,

0.5≤x≤1.8, 0<y≤1, 0≤z≤1, 0≤a≤0.05, and 0≤y+z≤1,

M¹, M², and M³ each independently are or include at least one element such as or including at least one of nickel (Ni), cobalt (Co), manganese (Mn), aluminum (Al), boron (B), barium (Ba), calcium (Ca), cerium (Ce), chromium (Cr), iron (Fe), molybdenum (Mo), niobium (Nb), silicon (Si), strontium (Sr), magnesium (Mg), titanium (Ti), vanadium (V), tungsten (W), zirconium (Zr), and lanthanum (La),

X is or includes at least one element such as or including at least one of fluorine (F), sulfur(S), phosphorus (P), and chlorine (Cl).

For example, a compound represented by any one of the Formulas below may be used as the lithium composite oxide. LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0≤α≤2); LiₐNi_{1-b-c}Mn_{b}X_{c}O_{2-α}D_{α} (0.90≤a≤1.8, 0≤b≤0.5, 0≤c≤0.5, 0≤α≤2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8).

In Formulas above, A is or includes at least one of Ni, Co, Mn, or a combination thereof, X is or includes at least one of Al, Ni, Co, Mn, Cr, Fe, Mg, Sr, V, a rare earth element, or a combination thereof, D is or includes at least one of O, F, S, P, or a combination thereof, G is or includes at least one of Al, Cr, Mn, Fe, Mg, La, Ce, Sr, V, or a combination thereof, and L¹ is or includes at least one of Mn, Al, or a combination thereof.

The lithium composite oxide may have a Ni content in a range of about 50 mol % or greater with respect to 100 mol % of metals excluding lithium. For example, the lithium composite oxide may have a Ni content of about 65 mol % or greater, about 80 mol % or greater, about 85 mol % or greater, about 90 mol % or greater, about 91 mol % or greater, or about 94 mol % or greater, or about 99 mol % or greater, with respect to 100 mol % of metals excluding lithium.

The positive electrode active material may include at least one of a lithium a cobalt-based oxide, a lithium nickel-based oxide, a lithium manganese-based oxide, a lithium iron phosphate-based compound, a cobalt-free nickel-manganese-based oxide, or a combination thereof.

For example, the positive electrode active material may include at least one of lithium iron phosphate (LFP), lithium manganese iron phosphate (LMFP), lithium nickel cobalt aluminum oxide (NCA), lithium nickel cobalt manganese oxide (NCM), lithium cobalt oxide (LCO), lithium manganese oxide (LMO), and lithium nickel manganese oxide (LNMO).

The positive electrode may include a binder. The positive electrode binder may attach positive electrode active material particles to one another, and to attach the positive electrode active material to the positive electrode current collector COL1.

The binder may attach positive electrode active material particles to one another, and to attach the positive electrode active material to the current collector COL1. Typical examples of the binder may be or include at least one of polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinyl pyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, and nylon, but the example embodiment of the present disclosure is not limited thereto.

As an example, the positive electrode may include at least one binder such as or including at least one of polyvinyl alcohol, carboxymethyl cellulose, hydroxypropyl cellulose, diacetyl cellulose, polyvinyl chloride, carboxylated polyvinyl chloride, polyvinyl fluoride, polyethylene oxide, polyvinyl pyrrolidone, polyurethane, polytetrafluoroethylene, polyvinylidene fluoride, polyethylene, and polypropylene.

In addition, the binder may amount to a range of about 0.5 wt % to about 5 wt % with respect to a total weight of the positive electrode. For example, the positive electrode binder may amount to a range of about 1 wt % to about 4.5 wt % or about 1.5 wt % to about 4 wt %, with respect to a total weight of the positive electrode.

The conductive material may impart conductivity to an electrode. Any material that does not cause an adverse chemical changes and that is an electron conductive material may be usable in batteries. Examples of the conductive material may include a carbon-based material such as at least one of natural graphite, artificial graphite, carbon black, acetylene black, ketjen black, a carbon fiber, a carbon nanofiber, and a carbon nanotube; a metal-based material including at least one of copper, nickel, aluminum, silver, and the like in a form of a metal powder or a metal fiber; a conductive polymer such as a polyphenylene derivative; or a mixture thereof.

As an example, the positive electrode may include a conductive material including a carbon-based material, a metal-based material in the form of metal powder or metal fiber, a conductive polymer, or a mixture thereof.

In addition, the conductive material may amount to a range of about 0.5 wt % to about 5 wt % with respect to a total weight of the positive electrode. For example, the positive electrode conductive material may amount to a range of about 0.5 wt % to about 4 wt %, about 0.5 wt % to about 3.5 wt %, or about 0.5 wt % to about 2 wt %, with respect to a total weight of the positive electrode.

Al may be used as the positive electrode current collector COL1, but the example embodiment of the present disclosure is not limited thereto.

### Negative Electrode

The electrode assembly according to an example embodiment of the present disclosure includes a negative electrode 20. For example, the negative electrode 20 may include a negative electrode current collector COL2 and a negative electrode active material layer AML2 disposed on at least one surface of the negative electrode current collector COL2. The negative electrode active material layer AML2 may include a negative electrode active material, and may further include a binder and/or a conductive material.

The negative electrode active material in the negative electrode active material layer AML2 may include at least one of a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, for example, crystalline carbon, amorphous carbon, or a combination thereof. Examples of the crystalline carbon may be graphite such as irregular, planar, flaky, spherical, or fibrous natural graphite or artificial graphite, and examples of the amorphous carbon may be or include at least one of soft carbon, hard carbon, mesophase pitch carbide, fired cokes, and the like.

The lithium metal alloy includes an alloy of lithium and a metal such as or including at least one of Na, K, Rb, Cs, Fr, Be, Mg, Ca, Sr, Si, Sb, Pb, In, Zn, Ba, Ra, Ge, Al, and Sn.

The material capable of doping/dedoping lithium may be or include a Si-based negative electrode active material or a Sn-based negative electrode active material. The Si-based negative electrode active material may be or include at least one of silicon, a silicon-carbon composite, SiOx (0<x≤2), a Si-Q alloy (where Q is or includes at least one of an alkali metal, an alkaline earth metal, a Group 13 element, a Group 14 element (except for Si), a Group 15 element, a Group 16 element, a transition metal, a rare-earth element, and a combination thereof), or a combination thereof. The Sn-based negative electrode active material may be or include at least one of Sn, SnO₂, a Sn-based alloy, or a combination thereof.

The silicon-carbon composite may be or include a composite of silicon and amorphous carbon. As an example, the silicon-carbon composite may be in a form of silicon particles and amorphous carbon coated on the surface of the silicon particles. For example, the silicon-carbon composite may include a secondary particle (core), in which primary silicon particles are assembled, and an amorphous carbon coating layer (shell) located on the surface of the secondary particle. The amorphous carbon may also be between the primary silicon particles, and, for example, the primary silicon particles may be coated with the amorphous carbon. In addition, the secondary particle may be dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material.

In addition, the negative electrode active material in the negative electrode active material layer AML2 may amount to a range of about 90 wt % to about 99 wt % of with respect to 100 wt % of the negative electrode active material layer AML2. For example, the negative electrode active material may amount to a range of about 93 wt % to about 99 wt % or about 96 wt % to about 98.5 wt %, with respect to a total weight of the negative electrode active material layer AML2.

As an example, the negative electrode active material may include at least one of graphite or a Si composite.

When the negative electrode active material includes both the Si composite and the graphite, the Si composite and the graphite may be included in the form of a mixture, and in this case, the Si composite and the graphite may be included in a weight ratio in a range of about 1:99 to about 50:50. For example, the Si composite and the graphite may be included in a weight ratio of about 3:97 to about 20:80 or about 5:95 to about 20:80.

The Si composite may include a core containing Si-based particles and an amorphous carbon coating layer, and for example, the Si-based particles may include at least one of a Si—C composite, SiOₓ (0<x≤2), or a Si alloy. For example, the Si—C composite may include a core containing Si particles and crystalline carbon, and an amorphous carbon coating layer placed on a surface of the core.

The crystalline carbon may include, for example, graphite, and for example, may include natural graphite, artificial graphite, or a mixture thereof.

As an example, the negative electrode active material may include a Si-based negative electrode active material. The Si-based active material has higher energy density than graphite, which is widely used as a negative electrode material and is a material that may be readily obtained from nature, but causes damage to an electrode due to about 300% or more of volume expansion during charge and discharge, and hardly enables high-speed charge and discharge. The electrode tab according to an example embodiment of the present disclosure includes an electrode tab including a first metal layer, a second metal layer, and a polymer layer interposed between the first metal layer and the second metal layer, and may thus effectively reduce or prevent deformation and damage of/to an electrode in a battery due to volume changes caused by charge/discharge or the like even when using a Si-based negative electrode active material.

The negative electrode may include a binder. The negative electrode binder may attach negative electrode active material particles to one another, and attach the negative electrode active material to the current collector COL2. The binder may include at least one of a non-aqueous binder, an aqueous binder, a dry binder, or a combination thereof.

The non-aqueous binder may be or include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, polyamide imide, polyimide, or a combination thereof.

The aqueous binder may be or include at least one of a styrene-butadiene rubber, a (meth)acrylated styrene-butadiene rubber, a (meth)acrylonitrile-butadiene rubber, a (meth)acrylic rubber, a butyl rubber, a fluoro rubber, polyethylene oxide, polyvinyl pyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, and a combination thereof.

When an aqueous binder is used as the negative electrode binder, a cellulose-based compound capable of imparting viscosity may be further included. As the cellulose-based compound, a mixture of one or more of carboxymethyl cellulose, hydroxypropylmethyl cellulose, methyl cellulose, or an alkali metal salt thereof may be used. The alkali metal salt may include at least one of Na, K, or Li.

The dry binder may be or include a polymer material that is capable of being fibrous. For example, the dry binder may be or include at least one of polytetrafluoroethylene, polyvinylidene fluoride, a polyvinylidene fluoride-hexafluoropropylene copolymer, polyethylene oxide, or a combination thereof.

In addition, the binder may amount to a range of about 0.5 wt % to about 5 wt % with respect to a total weight of the negative electrode. For example, the negative electrode active material layer may include the binder in an amount to about 0.5 wt % to about 3.5 wt % or about 0.5 wt % to about 2 wt %.

The negative electrode may include a conductive material. Descriptions of the conductive material are as described above.

In addition, the negative electrode current collector COL2 may include at least one of a copper foil, a nickel foil, a stainless steel foil, a titanium foil, a nickel foam, a copper foam, a polymer substrate coated with a conductive metal, or a combination thereof

### Separator

Depending on the type of rechargeable lithium battery, the separator 30 may be present between the positive electrode 10 and the negative electrode 20. The separator 30 may include at least one of polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The separator 30 may include a porous substrate and a coating layer including an organic material, an inorganic material, or a combination thereof on one surface, or on both surfaces, of the porous substrate.

The porous substrate may be or include a polymer film formed of or including any one polymer such as or including at least one of polyolefin such as polyethylene and polypropylene, polyester such as polyethylene terephthalate and polybutylene terephthalate, polyacetal, polyamide, polyimide, polycarbonate, polyether ketone, polyarylether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The organic material may include a polyvinylidene fluoride-based polymer or a (meth)acrylic polymer.

The inorganic material may include inorganic particles such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and the inorganic material may be mixed in one coating layer, or a coating layer including an organic material and a coating layer including an inorganic material may be stacked together.

### Electrolyte Solution ELL

The electrolyte solution ELL for a rechargeable lithium battery may include a non-aqueous organic solvent and a lithium salt.

The non-aqueous organic solvent may constitute a medium for transmitting ions taking part in the electrochemical reaction of a battery.

The non-aqueous organic solvent may be or include at least one of a carbonate-based, ester-based, ether-based, ketone-based, or alcohol-based solvent, an aprotic solvent, or a combination thereof. The non-aqueous organic solvents may be used alone or in combination of two or more solvents.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like.

The ester-based solvent may include at least one of methyl acetate, ethyl acetate, n-propyl acetate, dimethyl acetate, methyl propionate, ethyl propionate, decanolide, mevalonolactone, valerolactone, caprolactone, and the like.

The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone and the like. The alcohol-based solvent may include ethanol, isopropyl alcohol, and the like. The aprotic solvent may include at least one of nitriles such as R—CN (where R is a C2 to C20 linear, branched, or cyclic hydrocarbon group and may include a double bond, an aromatic ring, or an ether group); amides such as dimethylformamide; dioxolanes such as 1,3-dioxolane, 1,4-dioxolane; sulfolanes, and the like.

In addition, when using a carbonate-based solvent as the non-aqueous organic solvent, a cyclic carbonate and a chain carbonate may be mixed, and the cyclic carbonate and the chain carbonate may be mixed in a volume ratio in a range of about 1:1 to about 1:9.

For example, the non-aqueous organic solvent may include at least one of ethylene carbonate (EC), propylene carbonate (PC), propylpropionate (PP), ethylmethyl carbonate (EMC), dimethyl carbonate (DMC), diethyl carbonate (DEC), dipropyl carbonate (DPC), methylpropyl carbonate (MPC), ethylpropyl carbonate (EPC), methylethyl carbonate (MEC), and butylene carbonate (BC).

As an example, the non-aqueous organic solvent may be or include a mixed solvent of ethylene carbonate (EC), ethyl methyl carbonate (EMC), and dimethyl carbonate (DMC).

As an example, the ethylene carbonate (EC) may be included in an amount in a range of about 10 vol % to about 30 vol % with respect to a total amount of the non-aqueous organic solvent. The ethyl methyl carbonate (EMC) may be included in an amount in a range of about 20 vol % to about 70 vol %, or about 35 vol % to about 60 vol %, with respect to a total amount of the non-aqueous organic solvent. The dimethyl carbonate (DMC) may be included in an amount in a range of about 5 vol % to about 50 vol %, or about 10 vol % to about 40 vol %, with respect to a total amount of the non-aqueous organic solvent.

The ethylene carbonate (EC), the ethyl methyl carbonate (EMC), and the dimethyl carbonate (DMC) may be provided in a volume ratio of 1:a:b. In this case, a may be in a range of 1 to 3 or 1.5 to 2.5, and b may be in a range of 0.5 to 2 or 0.5 to 1.5.

The lithium salt dissolved in the organic solvent is configured to supply lithium ions in a battery, to enable operation of a rechargeable lithium battery, and to improve transportation of the lithium ions between positive and negative electrodes. Typical examples of the lithium salt may include at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (where x and y are integers of 1 to 20), lithium trifluoromethane sulfonate, lithium tetrafluoroethanesulfonate, lithium difluorobis(oxalato)phosphate (LiDFBOP), and lithium bis(oxalato) borate (LiBOB).

As an example, the lithium salt may include at least one of LiPF₆, LiClO₄, LiBF₄, (lithium bis(fluorosulfonyl)imide (LiFSI), LiTFSI, LiSO₃CF₃, LiBOB, LiFOB, LiDFBP, LiTFOP, LiPO₂F₂, LiSbF₆, LiAsF₆, LiAlO₂, LiAlCl₄, LiCl, LiI, LiN(SO₃C₂F₅)₂, Li(FSO₂)₂N, and LiC₄F₉SO₃. For example, the lithium salt may be or include LiPF₆.

In addition, the lithium salt may have a concentration in a range of about 0.1 M to about 2.0 M. For example, the lithium salt may have a concentration of about 0.5 M or more or about 1.0 M or more, and may have a concentration of about 2.0 M or less, about 1.7 M or less, or about 1.5 M or less. When the concentration of the lithium salt satisfies the above range, the conductivity and the viscosity of the electrolyte solution may be maintained as desired.

### Rechargeable Lithium Battery

A rechargeable lithium battery according to another example embodiment of the present disclosure includes a wound electrode assembly, and a cylindrical outer casing that houses the wound electrode assembly. The wound electrode assembly includes a positive electrode, a negative electrode, and at least one electrode tab electrically connected to the negative electrode, the negative electrode active material layer includes a Si-based negative electrode active material, and the electrode tab includes a first metal layer, a second metal layer, and a polymer layer interposed between the first metal layer and the second metal layer.

Descriptions of the electrode assembly are as described above.

FIG. 6 is a cross-sectional view of a rechargeable lithium battery according to another example embodiment of the present disclosure. Referring to FIG. 6, the rechargeable lithium battery according to another example embodiment of the present disclosure may be a cylindrical rechargeable lithium battery. The cylindrical rechargeable lithium battery shows an electrode assembly wound inside a cylindrical outer casing CAS as an example, and the electrode assembly may include a negative electrode 20, a separator 30, and a positive electrode 10, and shows a plurality of electrode tabs TB1 and TB2 protruding from the negative electrode 20 and from the positive electrode 10.

For example, the electrode tabs TB may include a positive electrode tab TB1 protruding from the positive electrode 10, and a negative electrode tab TB2 protruding from the negative electrode 20. The positive electrode tab TB1 may protrude to an upper portion of the electrode assembly, and the negative electrode tab TB2 may protrude to a lower portion of the electrode assembly. In addition, although FIG. 6 shows only a positive electrode lead tab LTB1 electrically connected to the positive electrode tab TB1, a negative electrode lead tab (not shown) electrically connected to the negative electrode tab TB2 may also be included.

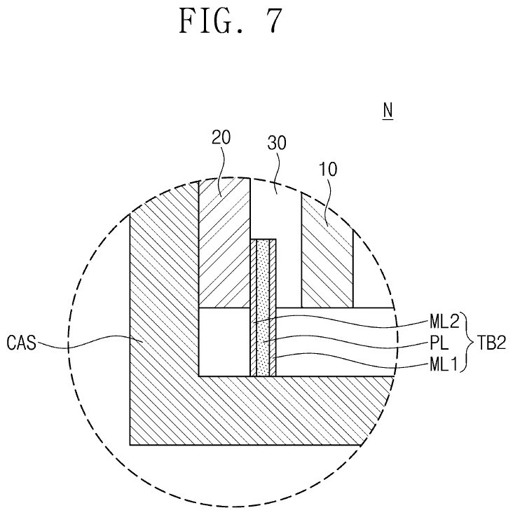

FIG. 7 is a schematic cross-sectional view enlarging region “N” of FIG. 6. Referring to FIG. 7, the negative electrode tab TB2 may include a first metal layer ML1, a second metal layer ML2, and a polymer layer PL. For example, the negative electrode tab TB2 may have a structure in which the second metal layer ML2, the polymer layer PL, and the first metal layer ML1 are stacked, e.g., sequentially stacked, and the second metal layer ML2 may be electrically connected while in contact with the negative electrode 20, for example, while in contact with the negative electrode current collector COL2.

Hereinafter, Examples and Comparative Examples of the present disclosure are described. However, the following Examples are presented only as an example embodiment of the present disclosure, and the present disclosure is not limited to Examples below.

### EXAMPLE

### Manufacture of Rechargeable Lithium Battery

### Example 1

96 wt % of LiCoO₂, 2 wt % of polyvinylidene fluoride (PVdF), and 2 wt % of carbon black were mixed in N-methylpyrrolidone to prepare a positive electrode slurry. The positive electrode slurry was applied onto a 10 μm thick Al foil, dried, and rolled to prepare a positive electrode.

20 wt % of a silicon-carbon composite, 78 wt % of graphite, 1 wt % of carboxymethyl cellulose, and 1 wt % of styrene-butadiene rubber (SBR) were mixed in distilled water to prepare a negative electrode slurry. The negative electrode slurry was applied onto a 10 μm thick Cu foil, dried, and rolled to prepare a negative electrode.

A 30 μm thick polypyrrole polymer layer was disposed between two 10 μm thick metal layers (Al) and rolled to prepare a positive electrode tab, and a 30 μm thick polypyrrole polymer layer was disposed between two 10 μm thick metal layers (alloy of Cu and Ni) and rolled to prepare a negative electrode tab.

The negative electrode, the positive electrode, and the 10 μm thick polyethylene separator were assembled, and the positive electrode tab was welded to one side of the Al foil and the negative electrode tab was welded to one side of the Cu foil to prepare an electrode assembly, and then an electrolyte solution was injected to manufacture a cylindrical rechargeable lithium battery. As the electrolyte solution, one in which 1.5 M LiPF₆ was dissolved in an organic solvent where ethylene carbonate (EC), diethyl carbonate (DEC), and dimethyl carbonate (DMC) were mixed in a volume ratio of 2:1:7, and 3 parts by weight of fluoroethylene carbonate (FEC) was added with respect to 100 parts by weight of the organic solvent was used.

### Comparative Example 1

A cylindrical rechargeable lithium battery was manufactured in the same manner as in Example 1, with a difference that positive and negative electrode tabs with no inclusion of a polypyrrole polymer layer were used.

### Comparative Example 2

A cylindrical rechargeable lithium battery was manufactured in the same manner as in Example 1, with a difference that a polyethylene terephthalate polymer layer was used instead of a polypyrrole polymer layer.

### Evaluation Example 1: Evaluation of Charge/Discharge Characteristics at Room Temperature

The rechargeable lithium batteries manufactured in Example 1 and Comparative Examples 1 and 2 were evaluated for charge/discharge characteristics. Specifically, the rechargeable lithium batteries were subjected to 1,000 charge/discharge cycles under the conditions of charge (0.5 C, CC/CV, 4.4 V, C/4.4V, 0.2 C cut-off)/discharge (0.5 C, CC, 2.5 V cut-off) at 25° C., and changes in retention capacity and direct current internal resistance (DC-IR) were measured. In this case, the capacity retention (%) was calculated through Equation A below, and DC-IR change rate (%) was calculated through Equation B below.

$$Capacity retention = ( discharge capacity after 1 , 000 cycles ) / ( discharge capacity after 1 cycle ) \times 100 \qquad Equation A$$

$$DC - IR change rate = ( DC - IR after 1 , 000 cycles / initial DC - IR ) \times 100 \qquad Equation B$$

TABLE 1

| | Capacity | DC-IR change |
|---|---|---|
| Item | retention (%) | rate (%) |
| Example 1 | 77% | 150% |
| Comparative Example 1 | 72% | 170% |
| Comparative Example 2 | 61% | 210% |

As shown in Table 1, the cylindrical rechargeable lithium battery of Example 1 has better charge/discharge characteristics at room temperature than Comparative Examples 1 and 2, and thus has improved life characteristics and safety.

An electrode assembly according to an example embodiment of the present disclosure includes an electrode tab including a first metal layer, a second metal layer, and a polymer layer interposed between the first metal layer and the second metal layer, and may thus reduce or prevent deformation of an electrode in a battery due to volume changes caused by charging/discharging or the like, thereby improving life characteristics and safety.

In addition, a rechargeable lithium battery according to another embodiment of the present disclosure includes an electrode assembly having the above-described technical features, and may thus reduce or prevent defects such as cracks or electrolyte leakage that may be caused by winding, thereby exhibiting desired or improved performance.

Although example embodiments of the present disclosure have been described above, the scope of the present disclosure is not limited to the example embodiments. Various modifications of the example embodiments may be made without departing from the spirit and scope of the disclosure as defined by the appended claims, and the modifications are included in the scope of the present disclosure.

What is claimed is:

1. An electrode assembly comprising:
at least one unit cell including a positive electrode and a negative electrode; and
at least one electrode tab electrically connected to one of the positive electrode and the negative electrode,
wherein the electrode tab includes a first metal layer, a second metal layer, and a polymer layer interposed between the first metal layer and the second metal layer, and
the polymer layer includes a polymer having a thermal conductivity in a range of about 10 W/m K or less.

2. The electrode assembly of claim 1, wherein the polymer layer comprises a polymer having a young's modulus in a range of about 5 GPa or less.

3. The electrode assembly of claim 1, wherein the polymer layer comprises a polymer having an electrical conductivity in a range of about 1.0×10⁻² S/cm to about 1.0×10⁵ S/cm.

4. The electrode assembly of claim 1, wherein the polymer layer comprises at least one of polypyrrole, polyaniline, polyphenylene, polyazulene, polythiophene, poly p-phenylene, poly p-phenylene vinylene, polyacetylene, polynaphthalene, polyphenylene sulfide, and poly(3,4-ethylenedioxythiophene):polystyrene sulfonate.

5. The electrode assembly of claim 1, wherein the polymer layer has a thickness in a range of about 0.5 μm to about 100 μm.

6. The electrode assembly of claim 1, wherein at least one of the first metal layer and the second metal layer comprise at least one of Ni, Cu, Al, Ti, stainless steel (SUS), or an alloy thereof.

7. The electrode assembly of claim 1, wherein at least one of the first metal layer and the second metal layer have thicknesses in a range of about 0.1 μm to about 50 μm.

8. The electrode assembly of claim 1, wherein the polymer layer is thicker than each of the first metal layer and the second metal layer.

9. The electrode assembly of claim 1, wherein a thickness ratio of the first metal layer, the polymer layer, and the second metal layer is about 1:2 to 30:0.5 to 1.5.

10. The electrode assembly of claim 1, wherein the electrode tab comprises:
a positive electrode tab protruding from the positive electrode; and
a negative electrode tab protruding from the negative electrode.

11. The electrode assembly of claim 10, wherein a direction in which the positive electrode tab protrudes and a direction in which the negative electrode tab protrudes are opposite to each other.

12. The electrode assembly of claim 10, wherein the first and second metal layers of the positive electrode tab have a lower electrical conductivity than the first and second metal layers of the negative electrode tab.

13. The electrode assembly of claim 10, wherein the first and second metal layers of the positive electrode tab have a lower hardness than the first and second metal layers of the negative electrode tab.

14. The electrode assembly of claim 1, wherein the negative electrode comprises a negative electrode current collector, and a negative electrode active material layer disposed on at least one surface of the negative electrode current collector.

15. The electrode assembly of claim 14, wherein the negative electrode active material layer comprises a Si-based negative electrode active material.

16. The electrode assembly of claim 1, wherein the positive electrode comprises a positive electrode current collector, and a positive electrode active material layer disposed on at least one surface of the positive electrode current collector.

17. The electrode assembly of claim 1, wherein the positive electrode active material layer comprises at least one of a lithium cobalt-based oxide, a lithium nickel-based oxide, a lithium manganese-based oxide, a lithium iron phosphate-based compound, and a cobalt-free nickel-manganese-based oxide.

18. The electrode assembly of claim 1, further comprising a lead tab electrically connected to the electrode tab.

19. A rechargeable lithium battery comprising:
a wound electrode assembly; and
a cylindrical outer casing that houses the wound electrode assembly,
wherein the wound electrode assembly includes a positive electrode, a negative electrode, and at least one electrode tab electrically connected to the negative electrode,
the negative electrode active material layer includes a Si-based negative electrode active material, and
the electrode tab includes a first metal layer, a second metal layer, and a polymer layer interposed between the first metal layer and the second metal layer.

20. The rechargeable lithium battery of claim 19, wherein:
the electrode tab comprises a positive electrode tab protruding from the positive electrode, and a negative electrode tab protruding from the negative electrode, and
the positive electrode tab protrudes from an upper portion of the electrode assembly, and the negative electrode tab protrudes from a lower portion of the electrode assembly.
